(19) United States
(12) Patent Application Publication
(10) Pub. No.: US 2004/0210369 A1
(43) Pub. Date: Oct. 21, 2004

(54) Automatic optical axis direction adjusting device for vehicle headlight

(75) Inventors: Ryu Mizuno, Kariya-city (JP); Koji Ishiguro, Toyoake-city (JP); Kazuhiko Kaiba, Kariya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref. (JP)

(21) Appl. No.: 10/817,849

(22) Filed: Apr. 6, 2004

(30) Foreign Application Priority Data
Apr. 21, 2003 (JP) 2003-116056
Feb. 16, 2004 (JP) 2004-38166

(51) Int. Cl. B60Q 1/06; G05D 1/00

(52) U.S. Cl. 701/49; 362/466

(57) ABSTRACT

In an automatic optical axis direction adjusting device for a vehicle headlight, a control characteristic is switched according to a road condition, a designation by a user or the like. Therefore, the optical axis direction of the vehicle headlight can be adjusted to suit a vehicle driving condition, a driver's preference or the like without causing a driver to feel uncomfortableness. Furthermore, the adjustment of the optical axis direction can be stopped or restricted according to the switched control characteristic. Therefore, unnecessary operation of a driving system such as an actuator can be avoided to increase durability.

### CROSS REFERENCE TO RELATED APPLICATION

This application is based on Japanese Patent Applications No. 2003-116056 filed on Apr. 21, 2003 and No. 2004-38166 filed on Feb. 16, 2004, the disclosures of which are incorporated herein by reference.

### BACKGROUND OF THE INVENTION

1. Field of the Invention

The present invention relates to an automatic optical axis direction adjusting device for a vehicle headlight, which automatically controls the optical axis direction or a lighting range of the vehicle headlight according to a steering angle of a steering wheel.

2. Description of Related Art

An automatic optical axis direction adjusting device for a vehicle headlight is disclosed, for example, in JP-A-H3-14742, JP-A-S64-74133, JP-A-H8-301005, JP-A-H11-235949 and JP-A-2002-234381.

In JP-A-H3-14742, a lighting angle of a headlight is set suitably based on a control characteristic according to a steering wheel position.

In JP-A-S64-74133, a change of a lighting direction of a headlight which is operated together with a steering wheel is restricted. This restriction is performed when the steering wheel is within a range of a predetermined steering angle from a straight steering position as a reference point.

In JP-A-H8-301005, a lighting angle of a headlight is controlled in left and right directions according to a steering angle of a steering wheel. In this technique, a changing rate of the lighting angle is set to be small when the steering angle is small, and the changing rate is set to be large when the steering angle is large. This control does not cause a driver to feel annoyance because the lighting angle does not change much in a corrective steering when a vehicle runs straight. To the contrary, this control can ensure visibility because the headlight, which is operated together with the steering wheel, can light in an advancing direction when the vehicle goes into a curve. In this case, the driver does not feel uncomfortableness.

In JP-A-H11-235949, a target optical axis angle of a headlight is calculated to approximate an actual brightness distribution to a target brightness distribution in a forward drive lane. Based on this calculated angle, an optical axis angle of the headlight is controlled by an actuator.

In JP-A-2002-234381, at least one of functions for adjusting an optical axis direction of a headlight is stopped when front visibility is ensured, for example, in a road sufficiently brightened by a streetlight. Thus, a driver does not feel uncomfortableness.

In the above patent documents JP-A-H3-14742, JP-A-S64-74133 and JP-A-H8-301005, an operation angle of the headlight is determined based on only one control characteristic which defines a relationship between the operation angle and a steering angle in advance. The headlight is swiveled for adjusting based on the above operation angle. Therefore, the headlight may not be suitably adjusted when a road condition changes. Furthermore, the adjustment may not suit for a driver's preference.

In JP-A-H11-235949, a camera is provided to calculate a brightness distribution or the like on a forward road. By processing image information from this camera, a brightness of light sources except for the headlight, for example, a streetlight, can be considered. Therefore, the headlight can light a drive lane efficiently. However, such an exaggerated system is unnecessary when front visibility is ensured, for example, in a road sufficiently brightened by a streetlight. To the contrary, such a system causes a driver to feel uncomfortableness because the optical axis direction is adjusted unnecessarily.

In this case, as described in JP-A-2002-234381, it is useful that at least one of functions for adjusting the optical axis direction of the headlight is stopped based on brightness around the vehicle, which is detected by a brightness sensor. However, it is guessed that the brightness sensor actually needs to detect brightness even outside an area where the headlight brightens a forward road. That is, the brightness sensor needs to detect brightness at multiple points in a predetermined area around the vehicle.

### SUMMARY OF THE INVENTION

In view of the foregoing problems, it is an object of the present invention to provide an automatic optical axis direction adjusting device for a vehicle headlight, which does not cause a driver to feel uncomfortableness by swiveling the headlight according to a change of a road condition and suits a driver's preference.

It is another object of the present invention to provide an automatic optical axis direction adjusting device for a vehicle headlight, which can decide necessity for an adjustment of the optical axis direction of the vehicle headlight without a brightness sensor and can avoid unnecessary operation of a driving system such as an actuator to increase durability by restricting or stopping the adjustment.

According to the present invention, an automatic optical axis direction adjusting device for a vehicle headlight includes a steering angle detecting device, a vehicle speed detecting device, an optical axis direction control device and a control characteristic switching means.

The steering angle detecting device detects a steering angle of a steering wheel of the vehicle. The vehicle speed detecting device detects a vehicle speed. The optical axis direction control device adjusts the optical axis direction of the headlight of the vehicle in any direction according to a control characteristic for the steering angle detected by the steering angle detecting device and the vehicle speed detected by the vehicle speed detecting device. The control characteristic switching means switches the control characteristic according to an outside information.

In the above automatic optical axis direction adjusting device for the vehicle headlight, the control characteristic is switched by the control characteristic switching means according to a road condition, a designation by a user or the like. Therefore, the optical axis direction of the vehicle headlight can be adjusted to suit a vehicle driving condition, a driver's preference or the like without causing a driver to feel uncomfortableness. Furthermore, the adjustment of the optical axis direction can be stopped or restricted according to the switched control characteristic. Therefore, unnecessary operation of a driving system such as an actuator can be avoided to increase durability.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic diagram showing an automatic optical axis direction adjusting device for a vehicle headlight according to a first to a fourth embodiments of the present invention;

FIG. 2 is a plan view showing a light distribution area of the vehicle headlight in the automatic optical axis direction adjusting device for the vehicle headlight according to the first embodiment;

FIG. 3 is a flow diagram showing a swivel control process in an electronic control unit (ECU) according to the first embodiment;

FIG. 4 is a flow diagram showing a swivel control process in the ECU according to the second embodiment of the present invention;

FIG. 5 is a relationship between a vehicle speed SPD and a threshold distance Dth between a vehicle and a preceding vehicle in the second embodiment;

FIG. 6 is a flow diagram showing a swivel control process in the ECU according to the third embodiment of the present invention;

FIG. 7 is a flow diagram showing a vehicle start/stop counter used in a swivel control process in the ECU according to the fourth embodiment of the present invention; and

FIG. 8 is a flow diagram showing the swivel control process in the ECU according to the fourth embodiment.

### DETAILED DESCRIPTION OF THE PRESENTLY PREFERRED EMBODIMENTS

(First Embodiment)

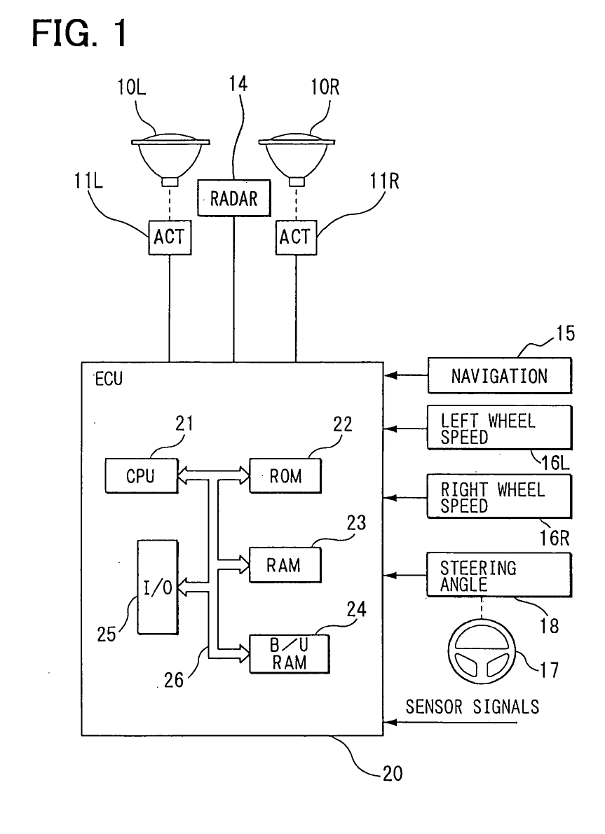

In the first embodiment, as shown in FIG. 1, left and right headlights 10L, 10R are provided on a front side of a vehicle. Actuators 11L, 11R for adjusting an optical axis direction are connected to the left and right headlights 10L, 10R respectively. An electric control unit (ECU) 20 is provided for controlling the optical axis direction of the vehicle headlight. It includes a well-known central processing unit (CPU) 21, a read only memory (ROM) 22, a random access memory (RAM) 23, a backup RAM 24, an input/output circuit 25 and a bus line 26 which connects the above devices. The CPU 21 performs various operations and processing. The ROM 22 stores a control program, a control characteristic of the optical axis direction of the left and right headlights 10L, 10R and the like. The RAM 23 stores various data.

Output signals from a well-known navigation system 15, a left wheel speed sensor 16L for detecting a left wheel speed, a right wheel speed sensor 16R for detecting a right wheel speed, a steering angle sensor 18 for detecting a steering angle STA of a steering wheel 17 which a driver operates and various sensors are inputted to the ECU 20. The ECU 20 outputs signals to the actuators 11L, 11R to adjust the optical axis direction of the left and right headlights 10L, 10R.

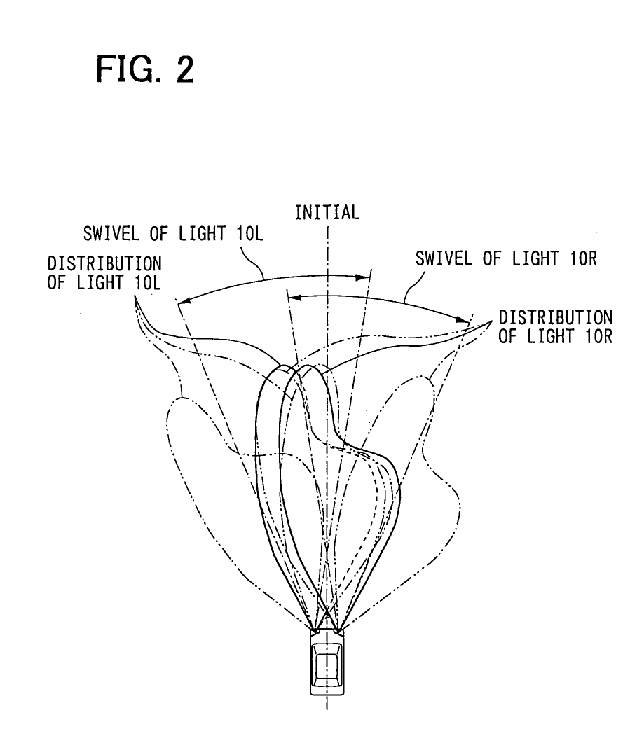

As shown in FIG. 2, a light distribution area of the left and right headlights 10L, 10R is adjusted in a left or right direction within a swivel control area, according to a steering in a left or right direction from a neutral point of the steering wheel 17. The swivel control area is set so that front visibility of the driver is not blocked and visibility in left and right directions is ensured while the driver operates the steering wheel 17. Therefore, the swivel control area of the headlight 10L in the left direction for the light distribution area of the headlight 10L is set to be larger than that of the headlight 10R in the left direction for the light distribution area of the headlight 10R when the steering wheel 17 is operated in the left direction. To the contrary, the swivel control area of the headlight 10R in the right direction for the light distribution area of the headlight 10R is set to be larger than that of the headlight 10L in the right direction for the light distribution area of the headlight 10L when the steering wheel 17 is operated in the right direction.

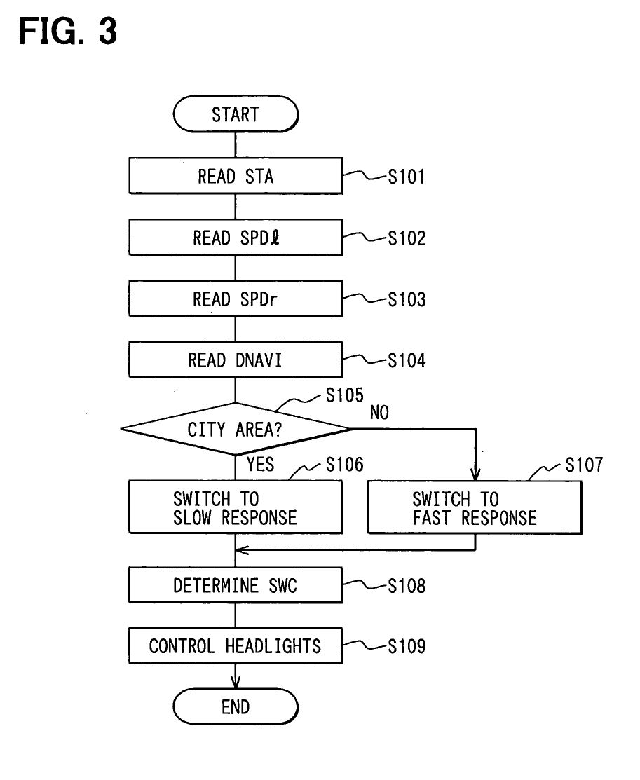

A swivel control process in FIG. 3 is repeated every predetermined control time. At step S101, the steering angle STA, which is detected by the steering angle sensor 18, is read. At step S102, a left wheel speed SPDl detected by the left wheel speed sensor 16L is read. At step S103, a right wheel speed SPDr detected by the right wheel speed sensor 16R is read. At step S104, a forward road information DNAVI is read from the navigation system 15. The forward road information DNAVI includes geographical map information, a vehicle position, landmarks, information for vehicle information and communication system (VICS).

At step S105, it is decided whether the vehicle runs in a city area. In this decision, the forward road information DNAVI from the navigation system 15 can be used. For example, an interval between intersections can be obtained by using the forward road information DNAVI. When the interval between the intersections is smaller than a predetermined distance, it is decided that the vehicle runs in the city area. When it is decided that the vehicle runs in the city area at step S105, the swivel control process proceeds to step S106. At step S106, the control characteristic is switched to a slow response control characteristic. The control characteristic is switched to the slow response control characteristic for the following reasons. In the city area, the steering wheel 17 is frequently operated to avoid obstacles or change drive lanes. In this case, it is preferable that the headlights 10L, 10R are moved slowly according to operation of the steering wheel 17 in order to prevent the driver from feeling uncomfortableness.

To the contrary, when it is not decided that the vehicle runs in the city area at step S105, the swivel control process proceeds to step S107. At step S107, the control characteristic is switched to a fast response control characteristic. The control characteristic is switched to the fast response control characteristic for the following reasons. In the non-city area such as a suburban area, the steering wheel 17 is frequently operated to adjust an advancing direction for curve. In this case, it is preferable that the headlights 10L, 10R are moved fast according to operation of the steering wheel 17 in order to prevent the driver from feeling uncomfortableness.

After the control characteristic is switched at step S106 or S107, the swivel control process proceeds to step S108. At step S108, based on the switched control characteristic, a swivel control angle SWC is determined according to the steering angle STA read at step S101 and a vehicle speed SPD based on the left wheel speed SPDl read at step S102 and the right wheel speed SPDr read at step S103.

At step S109, based on the above swivel control angle SWC, the actuators 11L, 11R are driven so that the optical axis direction of the headlights 10L, 10R is adjusted. Thereafter, the swivel control process is finished. Thus, the optical axis direction of the headlights 10L, 10R is suitably swiveled for a road condition change according to the driver's operation of the steering wheel 17.

In the first embodiment, the control characteristic is automatically switched according to the forward road information DNAVI from the navigation system 15. However, the driver may manually switch the control characteristic. In this case, a manual switch for switching the control characteristic is provided, for example, near the steering wheel 17 or an instrument panel. Thus, control response can be changed according to a driver's preference. Therefore, the swivel control, which does not cause the driver to feel uncomfortableness according to operation of the steering wheel 17, can be achieved.

Further, in the first embodiment, the swivel control angle SWC, which relates to the operation response of the optical axis direction adjustment of the headlights 10L, 10R, is determined by using the switched control characteristic. Based on the swivel control angle SWC, the optical axis direction of the headlights 10L, 10R is horizontally swiveled in the left and right directions. It is however possible that a swivel control range (operation angle range) is determined by using a switched control characteristic. In this case, for example, the control characteristic is switched to a control characteristic that the swivel control range becomes narrow in the city area and becomes wide in the non-city area. Thus, the forward road condition can be appropriately recognized according to the steering wheel 17 and the swivel control without causing the driver to feel uncomfortableness can be achieved.

In the first embodiment, the swivel control is performed for the headlights 10L, 10R. However, the swivel control can be performed for left and right swiveling lights. The left and right swiveling lights are used only for swiveling and are provided separately from the headlights 10L, 10R. In addition, it is also possible that the swivel control is performed for both of the headlights 10L, 10R and the left and right swiveling lights.

(Second Embodiment)

In the second embodiment, an automatic optical axis direction adjusting device for a vehicle headlight is constructed similarly to the first embodiment. However, a well-known laser radar 14 is additionally provided as shown in FIG. 1 in order to measure a distance between a vehicle and a preceding vehicle. The laser radar 14 is disposed, for example, in a front bumper. An output signal from the laser radar 14 is also inputted to the ECU 20.

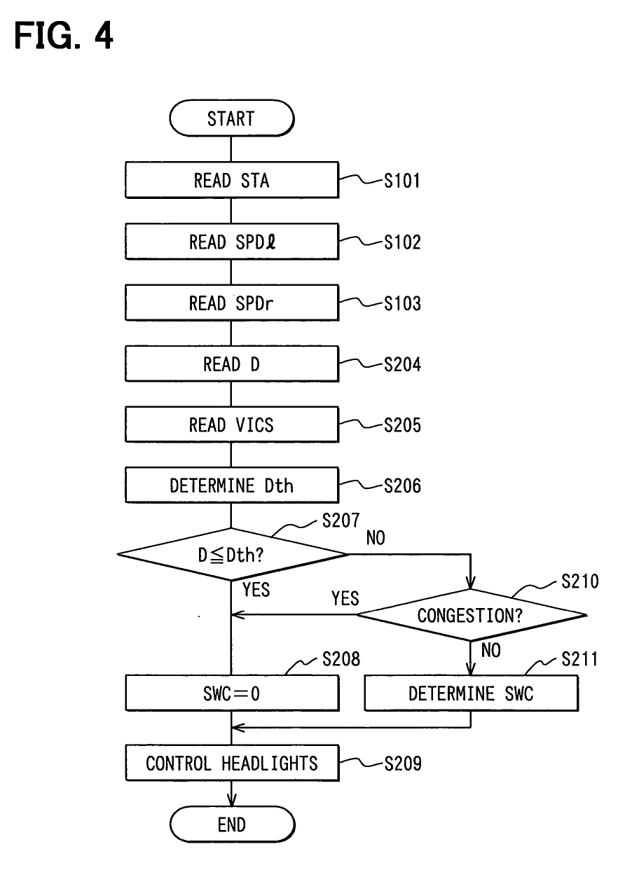

A swivel control process in FIG. 4 is repeated every predetermined control time. At step S204, a distance D between the vehicle and a preceding vehicle is read from the laser radar 14. At step S205, the information for VICS in the forward road information DNAVI from the navigation system 15 is read. The forward road information DNAVI includes geographical map information, a vehicle position, landmarks and the like in addition to the information for VICS.

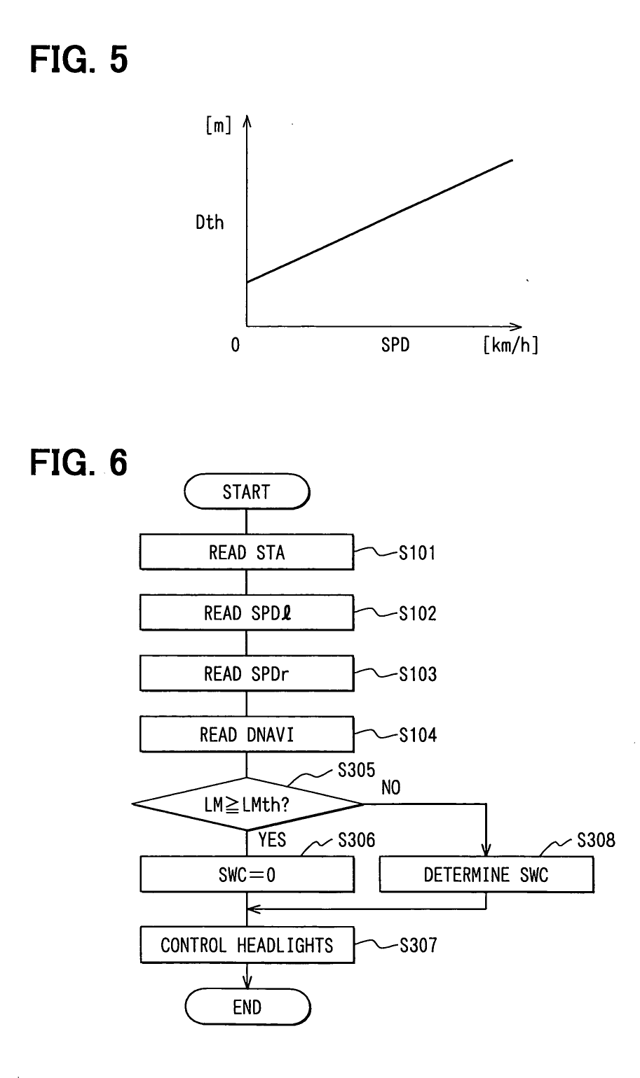

At step S206, a threshold distance Dth between the vehicle and the preceding vehicle is determined. The threshold distance Dth is a function of the vehicle speed SPD based on the left wheel speed SPDl read at step S102 and the right wheel speed SPDr read at step S103. Specifically, the threshold distance Dth is determined by using a relationship shown in FIG. 5. At step S207, it is decided whether the distance D read at step S204 is less than the threshold distance Dth determined at step S206. When it is decided that the distance D is less than the threshold distance Dth at step S207, it is decided that the vehicle is close to the preceding vehicle, that is, the road is congested with traffic. In this case, a control characteristic is switched to stop an adjustment of the optical axis direction. That is, at step S208, a swivel control angle SWC is set to 0. Thereafter, the swivel control process proceeds to step S209.

At step S209, the optical axis direction of the headlights 10L, 10R is controlled. Specifically, an output signal based on the swivel control angle SWC (=0) is inputted to the actuators 11L, 11R of the headlights 10L, 10R. Thus, the optical axis direction of the headlights 10L, 10R is returned to an initial position and the swivel control process is finished.

To the contrary, when it is decided that the distance D is more than the threshold distance D that step S207, the swivel control process proceeds to step S210. At step S210, it is decided whether the forward road is congested with traffic. When it is decided that the forward road is congested with traffic from the information for VICS read at step S205, the swivel control process proceeds to step S208. Thereafter, similar to the above process, the optical axis direction of the headlights 10L, 10R is returned to the initial position and the swivel control process is finished.

To the contrary, when it is decided that the forward road is not congested with traffic from the information for VICS at step S210, the control characteristic is switched to a control characteristic which is different from that for stopping the adjustment of the optical axis direction. At step S211, by using this switched control characteristic, the swivel control angle SWC is determined according to the steering angle STA read at step S101 and the vehicle speed SPD based on the left wheel speed SPDl read at step S102 and the right wheel speed SPDr read at step S103. Thereafter, the swivel control process proceeds to step S209.

At step S209, an output signal based on the swivel control angle SWC determined at step S211 is inputted to the actuators 11L, 11R of the headlights 10L, 10R. Thus, the optical axis direction of the headlights 10L, 10R is adjusted and the swivel control process is finished.

In the second embodiment, a condition outside the vehicle can be obtained based on the distance D between the vehicle and the preceding vehicle, which is measured by the laser radar 14, and the information for VICS in the forward road information DNAVI from the navigation system 15. Thus, necessity for adjustment of the optical axis direction of the vehicle headlights 10L, 10R can be decided without a brightness sensor. In addition, unnecessary operation of a driving system such as the actuators 11L, 11R can be avoided to increase durability by restricting or stopping the adjustment.

Furthermore, in the second embodiment, a well-known radar cruise control system (not shown) can be added to the vehicle. The radar cruise control system is a device which controls the vehicle to automatically follow a preceding vehicle. When the vehicle automatically follows the preceding vehicle by the operation of the radar cruise control system, the swivel control angle SWC is set to 0 similarly to the above swivel control process. Thereafter, the optical axis direction of the headlights 10L, 10R is returned to the initial position. In this automatic adjusting device including the above radar cruise control system, the same operation and effect as those of the embodiment without the above radar cruise control system can be expected.

(Third Embodiment)

An automatic optical axis direction adjusting device for a vehicle headlight according to the third embodiment is a modification of that of the second embodiment.

Similarly to the first and the second embodiment, a swivel control process in FIG. 6 is repeated every predetermined control time. At step S305, it is decided whether a number LM of landmarks in a predetermined area from the vehicle position is more than a predetermined number LMth. The vehicle position and the number LM can be obtained based on the forward road information DNAVI read at step S104. When it is decided that the number LM is more than the number LMth at step S305, it is decided that the vehicle runs in a city area. In this case, a control characteristic is switched to stop an adjustment of the optical axis direction. That is, at step S306, the swivel control angle SWC is set to 0. Thereafter, the swivel control process proceeds to step S307.

At step S307, the optical axis direction of the headlights 10L, 10R is controlled. Specifically, an output signal based on the swivel control angle SWC (=0) is inputted to the actuators 11L, 11R of the headlights 10L, 10R. Thus, the optical axis direction of the headlights 10L, 10R is returned to an initial position and the swivel control process is finished.

To the contrary, when it is decided that the number LM is less than the number LMth at step S305, it is decided that the vehicle runs in a non-city area. In this case, the control characteristic is switched to a control characteristic which is different from that for stopping the adjustment of the optical axis direction. At step S308, by using this switched control characteristic, the swivel control angle SWC is determined according to the steering angle STA read at step S101 and the vehicle speed SPD based on the left wheel speed SPDl read at step S102 and the right wheel speed SPDr read at step S103. Thereafter, the swivel control process proceeds to step S307.

At step S307, an output signal based on the swivel control angle SWC determined at step S308 is inputted to the actuators 11L, 11R of the headlights 10L, 10R. Thus, the optical axis direction of the headlights 10L, 10R is adjusted and the swivel control process is finished.

In the third embodiment, a condition outside the vehicle can be obtained based on the number LM of landmarks in the predetermined area from the forward road information DNAVI. Thus, necessity for adjustment of the optical axis direction of the vehicle headlights 10L, 10R can be decided without a brightness sensor. In addition, unnecessary operation of a driving system such as the actuators 11L, 11R can be avoided to increase durability by restricting or stopping the adjustment.

(Fourth Embodiment)

An automatic optical axis direction adjusting device for a vehicle headlight according to the fourth embodiment is also a modification of that of the second embodiment.

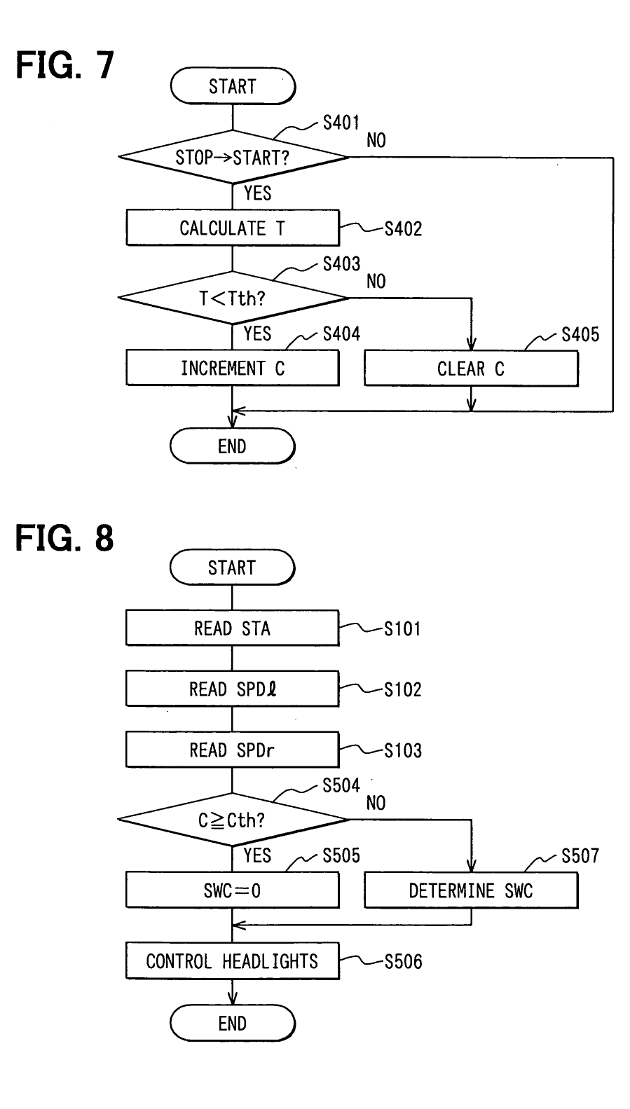

When a vehicle starts from a stop state for the first time after a driver starts the vehicle, an internal timer is started and a vehicle start/stop counter shown in FIG. 7 is started. Here, it is decided that the vehicle starts from the stop state, for example, when the vehicle speed SPD based on the left wheel speed SPDl and the right wheel speed SPDr becomes less than 3 km/h once and becomes more than 5 km/h again after the elapse of 2 seconds.

At step S401, it is decided whether the vehicle starts again from the stop state. When it is not decided that the vehicle starts again from the stop state, a routine of the vehicle start/stop counter is finished immediately. To the contrary, when it is decided that the vehicle starts again from the stop state, the routine of the vehicle start/stop counter proceeds to step S402. At step S402, a time interval T between a previous start from the stop state and the start at this time is calculated based on the internal timer.

Next, at step S403, it is decided whether the time interval T calculated at step S402 is less than a predetermined threshold time Tth. When it is decided that the time interval T is less than the predetermined threshold time Tth, the routine of the vehicle start/stop counter proceeds to step S404. At step S404, a count C of the vehicle start/stop counter is incremented by one count and the routine is finished. To the contrary, when it is decided that the time interval T is more than the predetermined threshold time Tth, the routine of the vehicle start/stop counter proceeds to step S405. At step S405, the count C of the vehicle start/stop counter is cleared to 0 and the routine is finished.

Next, a swivel control process in FIG. 8 is started. At step S504, it is decided whether the count C of the vehicle start/stop counter is more than a predetermined threshold value Cth. When it is decided that the count C of the vehicle start/stop counter is more than the predetermined threshold value Cth, it is decided that the vehicle runs in a city area because the vehicle frequently starts and stops at the short time interval T. In this case, a control characteristic is switched to stop an adjustment of the optical axis direction. That is, at step S505, a swivel control angle SWC is set to 0. Thereafter, the swivel control process proceeds to step S506.

At step S506, the optical axis direction of the headlights 10L, 10R is controlled. Specifically, an output signal based on the swivel control angle SWC (=0) is inputted to the actuators 11L, 11R of the headlights 10L, 10R. Thus, the optical axis direction of the headlights 10L, 10R is returned to an initial position and the swivel control process is finished.

To the contrary, when it is decided that the count C of the vehicle start/stop counter is less than the predetermined threshold value Cth, it is decided that the vehicle runs in a non-city area because the vehicle does not frequently start and stop at the short time interval T. In this case, the control characteristic is switched to a control characteristic which is different from that for stopping the adjustment of the optical axis direction. At step S507, by using this switched control characteristic, the swivel control angle SWC is determined according to the steering angle STA read at step S101 and the vehicle speed SPD based on the left wheel speed SPDl read at step S102 and the right wheel speed SPDr read at step S103. Thereafter, the swivel control process proceeds to step S506.

At step S506, an output signal based on the swivel control angle SWC determined at step S507 is inputted to the actuators 11L, 11R of the headlights 10L, 10R. Thus, the optical axis direction of the headlights 10L, 10R is adjusted and the swivel control process is finished.

In the fourth embodiment, it is decided whether the vehicle runs in the city area based on times of vehicle start and stop. When it is decided that the vehicle runs in the city area, the control characteristic is switched to stop the adjustment of the optical axis direction of the headlights 10L, 10R. Thus, unnecessary operation of a driving system such as the actuators 11L, 11R can be avoided to increase durability.

In the second, third and fourth embodiments, when it is decided that the vehicle runs in the city area or the road is congested with traffic, the control characteristic is switched to the control characteristic for stopping the adjustment of the optical axis direction and the headlights 10L, 10R are returned to the initial position. However, it is possible that the swivel control angle SWC, determined according to a control characteristic which is different from that for stopping the adjustment of the optical axis direction, is multiplied with a predetermined rate. Thus, the swivel control range in the adjustment of the optical axis direction of the left and right headlights 10L, 10R can be reduced. Similarly, it is also possible that the swivel control angle SWC is filtered. Thus, the optical axis direction of the left and right headlights 10L, 10R can be adjusted slowly. In the automatic adjusting device which restricts the adjustment of the optical axis direction of the headlights 10L, 10R as described above, the same operation and effect as those of the second, third and fourth embodiments can be expected.

Further, it is possible that some of the first to the fourth embodiments described above are combined to provide an automatic optical axis direction adjusting device for a vehicle headlight.

What is claimed is:

1. An automatic optical axis direction adjusting device for a headlight of a vehicle, comprising:
a steering angle detecting device for detecting a steering angle of a steering wheel of the vehicle;
a vehicle speed detecting device for detecting a vehicle speed; and
an optical axis direction control device for adjusting the optical axis direction of the headlight of the vehicle in any direction according to a control characteristic for the steering angle detected by the steering angle detecting device and the vehicle speed detected by the vehicle speed detecting device, characterized in that the optical axis direction control device includes a control characteristic switching means for switching the control characteristic according to an outside information.

2. The automatic optical axis direction adjusting device for the headlight of the vehicle according to claim 1, wherein the control characteristic switching means switches the control characteristic according to a designation by a user.

3. The automatic optical axis direction adjusting device for the headlight of the vehicle according to claim 1, wherein:
the control characteristic switching means decides whether the vehicle runs in a city area; and
the control characteristic switching means switches the control characteristic in order to stop or restrict an adjustment of the optical axis direction of the headlight of the vehicle when the control characteristic switching means decides that the vehicle runs in the city area.

4. The automatic optical axis direction adjusting device for the headlight of the vehicle according to claim 3, wherein the control characteristic switching means decides whether the vehicle runs in the city area by using a forward road information from a navigation system mounted in the vehicle.

5. The automatic optical axis direction adjusting device for the headlight of the vehicle according to claim 3, wherein the control characteristic switching means decides that the vehicle runs in the city area when the number of times of starts and stops of the vehicle determined based on a change of the vehicle speed detected by the vehicle speed detecting device is more than a predetermined value.

6. The automatic optical axis direction adjusting device for the headlight of the vehicle according to claim 1, wherein:
the control characteristic switching means decides whether the vehicle is in a traffic congestion; and
the control characteristic switching means switches the control characteristic in order to stop or restrict an adjustment of the optical axis direction of the headlight of the vehicle when the control characteristic switching means decides that the vehicle is in the traffic congestion.

7. The automatic optical axis direction adjusting device for the headlight of the vehicle according to claim 6, wherein the control characteristic switching means decides whether the vehicle is in the congestion by using a forward road information from a navigation system mounted in the vehicle.

8. The automatic optical axis direction adjusting device for the headlight of the vehicle according to claim 6, wherein the control characteristic switching means decides that the vehicle is in the congestion when a distance between the vehicle and a preceding vehicle, which is measured by a distance measuring system mounted in the vehicle, is less than a predetermined value.

9. The automatic optical axis direction adjusting device for the headlight of the vehicle according to claim 1, wherein the control characteristic switching means switches the control characteristic in order to stop or restrict an adjustment of the optical axis direction of the headlight of the vehicle when the vehicle is automatically controlled to follow a preceding vehicle by a following drive control device mounted in the vehicle.

10. The automatic optical axis direction adjusting device for the headlight of the vehicle according to claim 1, wherein the optical axis direction control device swivels the optical axis direction of the headlight of the vehicle horizontally in right and left directions or vertically.

11. The automatic optical axis direction adjusting device for the headlight of the vehicle according to claim 1, wherein the control characteristic is stored in a memory device.

12. The automatic optical axis direction adjusting device for the headlight of the vehicle according to claim 11, wherein:
the memory device stores a plurality of control characteristics corresponding to different control response speeds; and
the control characteristic switching means selects one of the control characteristics corresponding to a slow response speed when the vehicle is in a city area.
